(19) United States
(12) Patent Application Publication
(10) Pub. No.: US 2025/0170806 A1
(43) Pub. Date: May 29, 2025

(54) LAMINATED FABRIC/FILM MATERIAL THAT IS SUBSTANTIALLY GAS AND WATER VAPOR IMPERMEABLE

(71) Applicant: Midwest Canvas Corporation, Chicago, IL (US)

(72) Inventors: Alex Handwerker, Chicago, IL (US); Barry Handwerker, Glencoe, IL (US); Blake Handwerker, Chicago, IL (US)

(73) Assignee: Midwest Canvas Corporation, Chicago, IL (US)

(21) Appl. No.: 18/522,990

(22) Filed: Nov. 29, 2023

(51) Int. Cl. B32B 27/12; B32B 5/02; B32B 27/18; B32B 27/32

(52) U.S. Cl. CPC B32B 27/12; B32B 5/024; B32B 27/18; B32B 27/32; B32B 2250/02; B32B 2250/242; B32B 2255/02; B32B 2307/7244; B32B 2307/7246

(57) ABSTRACT

In aspects, the present disclosure provides laminated films and methods of making the films, the film comprising: (a) a fabric polymeric layer, wherein the fabric polymeric layer is woven, and wherein the fabric polymeric layer comprises polyethylene (PE) or polypropylene (PP); and (b) an extruded polymeric layer, wherein the extruded polymeric layer comprises an additive incorporated into the layer that makes the layer substantially impermeable to gases.

### BACKGROUND

There are some fabrics/films that are currently available in the marketplace that are substantially impermeable to gas and/or water vapor; however, these fabrics/films do not possess high strength (impact and/or tensile). Therefore, there is a need for a fabric/film that is substantially impermeable to gas and water vapor, where the fabric/film has high strength.

### BRIEF SUMMARY

In aspects, the present disclosure provides a laminated film comprising, consisting essentially of, or consisting of: (a) a fabric polymeric layer, wherein the fabric polymeric layer is woven, and wherein the fabric polymeric layer comprises, consists essentially of, or consists of polyethylene (PE) or polypropylene (PP); and (b) an extruded polymeric layer, wherein the extruded polymeric layer comprises, consists essentially of, or consists of an additive incorporated into the layer that makes the layer substantially impermeable to gases.

In aspects, the present disclosure provides a method of making a laminated film, the method comprising, consisting essentially of, or consisting of: (1) forming an extruded polymeric layer from a polymer and an additive that makes the extruded polymeric layer substantially impermeable to gases; and (2) laminating the extruded polymeric layer of (1) onto a fabric polymeric layer, wherein the fabric polymeric layer is woven, and wherein the fabric polymeric layer comprises, consists essentially of, or consists of PE or PP.

Additional aspects of the present disclosure are as described herein.

### BRIEF DESCRIPTION OF THE DRAWING

FIG. 1 presents a diagram of an exemplary laminated film of the present disclosure.

### DETAILED DESCRIPTION

### Laminated Films of the Present Disclosure

In aspects, the present disclosure provides a laminated film comprising, consisting essentially of, or consisting of: (a) a fabric polymeric layer, wherein the fabric polymeric layer is woven, and wherein the fabric polymeric layer comprises, consists essentially of, or consists of PE or PP; and (b) an extruded polymeric layer, wherein the extruded polymeric layer comprises, consists essentially of, or consists of an additive incorporated into the layer that makes the layer substantially impermeable to gases.

The fabric polymeric layer comprises, consists essentially of, or consists of any suitable woven plastic fabric. In aspects, the fabric polymeric layer comprises, consists essentially of, or consists of any PE or PP. In aspects, the fabric polymeric layer comprises, consists essentially of, or consists of PE, which may be high density PE (HDPE). In aspects, the fabric polymeric layer comprises, consists essentially of, or consists of PP.

The woven plastic fabric can be comprised of any suitable weave. Exemplary weaves include on a circular loom, a seltzer loom, a flat loom, or a water jet loom. The weave density can be any suitable value, for example, 6, 8, 10, 12, 16, or higher threads or tapes per inch.

In aspects, the fabric polymeric layer is not coated on either side. In aspects, the fabric polymeric layer is coated on one side. In aspects, the extruded polymeric layer is in contact with the non-coated side of the fabric polymeric layer. In aspects, the fabric polymeric layer is coated on both sides. In aspects, the coating comprises, consists essentially of, or consists of any suitable polymer. In aspects, the coating comprises, consists essentially of, or consists of low density polyethylene (LDPE).

The fabric polymeric layer can have any suitable thickness, for example, 50 grams per square meter (gsm) to 200 gsm. For example, the fabric polymeric layer can have a thickness of 50 gsm to 175 gsm, 50 gsm to 150 gsm, 50 gsm to 125 gsm, 50 gsm to 100 gsm, 50 gsm to 75 gsm, 75 gsm to 200 gsm, 75 gsm to 175 gsm, 75 gsm to 150 gsm, 75 gsm to 125 gsm, 75 gsm to 100 gsm, 100 gsm to 200 gsm, 100 gsm to 175 gsm, 100 gsm to 150 gsm, 100 gsm to 125 gsm, 125 gsm to 200 gsm, 125 gsm to 175 gsm, 125 gsm to 150 gsm, 150 gsm to 200 gsm, 150 gsm to 175 gsm, or 175 gsm to 200 gsm. For example, the fabric polymeric layer can have a thickness of 50 gsm. For example, the fabric polymeric layer can have a thickness of 200 gsm.

Any coating of the fabric polymeric layer can have any suitable thickness, for example, 1.25 mil to 60 mil (1 mil=0.0001 inch). For example, a coating of the fabric polymeric layer can have a thickness of 1.25 mil to 50 mil, 1.25 mil to 40 mil, 1.25 mil to 30 mil, 1.25 mil to 20 mil, 1.25 mil to 10 mil, 1.25 mil to 5 mil, 1.25 mil to 2 mil, 1.25 mil to 1.5 mil, 1.5 mil to 60 mil, 1.5 mil to 50 mil, 1.5 mil to 40 mil, 1.5 mil to 30 mil, 1.5 mil to 20 mil, 1.5 mil to 10 mil, 1.5 mil to 5 mil, 1.5 mil to 2 mil, 2 mil to 60 mil, 2 mil to 50 mil, 2 mil to 40 mil, 2 mil to 30 mil, 2 mil to 20 mil, 2 mil to 10 mil, 2 mil to 5 mil, 5 mil to 60 mil, 5 mil to 50 mil, 5 mil to 40 mil, 5 mil to 30 mil, 5 mil to 20 mil, 5 mil to 10 mil, 10 mil to 60 mil, 10 mil to 50 mil, 10 mil to 40 mil, 10 mil to 30 mil, 10 mil to 20 mil, 20 mil to 60 mil, 20 mil to 50 mil, 20 mil to 40 mil, 20 mil to 30 mil, 30 mil to 60 mil, 30 mil to 50 mil, 30 mil to 40 mil, 40 mil to 60 mil, 40 mil to 50 mil, or 50 mil to 60 mil. For example, a coating of the fabric polymeric layer can have a thickness of 1.25 mil. For example, a coating of the fabric polymeric layer can have a thickness of 60 mil.

In aspects, the fabric polymeric layer has high strength. In aspects, the high strength includes high impact strength, high tensile strength, or both, as measured by, for example, tensile grab strength (lb/f), mullen burst (psi), or both.

In aspects, the additive incorporated into the extruded polymeric layer is any suitable additive that makes the layer substantially impermeable to gases. Exemplary additives include ethylene vinyl alcohol (EVOH) and Nylon. In aspects, the additive is EVOH. In aspects, the additive is Nylon.

The extruded polymeric layer is formed any suitable weight percentage of additive. For example, the additive may be 1, 2, 3, 4, 5, 6, 7, 8, 9, 10 wt. % or higher.

In aspects, the extruded polymeric layer is formed from PE. The PE can be any suitable thickness, for example, 0.25 mil to 20 mil. For example, the extruded polymeric layer can have a thickness of 0.25 mil to 15 mil, 0.25 mil to 10 mil, 0.25 mil to 5 mil, 0.25 mil to 2 mil, 0.25 mil to 1 mil, 0.25 mil to 0.5 mil, 0.5 mil to 20 mil, 0.5 mil to 15 mil, 0.5 mil to 10 mil, 0.5 mil to 5 mil, 0.5 mil to 2 mil, 0.5 mil to 1 mil, 1 mil to 20 mil, 1 mil to 15 mil, 1 mil to 10 mil, 1 mil to 5 mil, 1 mil to 2 mil, 2 mil to 20 mil, 2 mil to 15 mil, 2 mil to 10 mil, 2 mil to 5 mil, 5 mil to 20 mil, 5 mil to 15 mil, 5 mil to 10 mil, 10 mil to 20 mil, 10 mil to 15 mil, or 15 mil to 20 mil. For example, the extruded polymeric layer can have a thickness of 0.25 mil. For example, the extruded polymeric layer can have a thickness of 20 mil.

In aspects, the extruded polymeric layer is substantially impermeable to all gases. In aspects, the extruded polymeric layer is substantially impermeable to any one or more of oxygen, water vapor, radon, methane, gaseous odors, and volatile organic compounds. In aspects, the extruded polymeric layer is substantially impermeable to oxygen and water vapor.

The laminated film can have any suitable total thickness, for example, 1.5 mil to 80 mil. For example, the laminated film can have a thickness of 1.5 mil to 70 mil, 1.5 mil to 60 mil, 1.5 mil to 50 mil, 1.5 mil to 40 mil, 1.5 mil to 30 mil, 1.5 mil to 20 mil, 1.5 mil to 10 mil, 1.5 mil to 5 mil, 1.5 mil to 2 mil, 2 mil to 80 mil, 2 mil to 70 mil, 2 mil to 60 mil, 2 mil to 50 mil, 2 mil to 40 mil, 2 mil to 30 mil, 2 mil to 20 mil, 2 mil to 10 mil, 2 mil to 5 mil, 5 mil to 80 mil, 5 mil to 70 mil, 5 mil to 60 mil, 5 mil to 50 mil, 5 mil to 40 mil, 5 mil to 30 mil, 5 mil to 20 mil, 5 mil to 10 mil, 10 mil to 80 mil, 10 mil to 70 mil, 10 mil to 60 mil, 10 mil to 50 mil, 10 mil to 40 mil, 10 mil to 30 mil, 10 mil to 20 mil, 20 mil to 80 mil, 20 mil to 70 mil, 20 mil to 60 mil, 20 mil to 50 mil, 20 mil to 40 mil, 20 mil to 30 mil, 30 mil to 80 mil, 30 mil to 70 mil, 30 mil to 60 mil, 30 mil to 50 mil, 30 mil to 40 mil, 40 mil to 80 mil, 40 mil to 70 mil, 40 mil to 60 mil, 40 mil to 50 mil, 50 mil to 80 mil, 50 mil to 70 mil, 50 mil to 60 mil, 60 mil to 80 mil, 60 mil to 70 mil, or 70 mil to 80 mil. For example, the laminated film can have a thickness of 1.5 mil. For example, the laminated film can have a thickness of 80 mil.

The dimensions of the laminated film are any length and width suitable, for example, for the uses described below.

An exemplary laminated film of the present disclosure is provided in the Example below.

### Methods of Making Laminated Films of the Present Disclosure

In aspects, the present disclosure provides a method of making a laminated film, the method comprising, consisting essentially of, or consisting of: (1) forming an extruded polymeric layer from a polymer and an additive that makes the extruded polymeric layer substantially impermeable to gases; and (2) laminating the extruded polymeric layer of (1) onto a fabric polymeric layer, wherein the fabric polymeric layer is woven, and wherein the fabric polymeric layer comprises, consists essentially of, or consists of PE or PP.

All aspects, including of the extruded polymeric layer, additive, and fabric polymeric layer, may be any of those as described in the Laminated Films of the Present Disclosure section above, including any combination of the aspects described.

In aspects, the fabric polymeric layer is not coated on either side, and the extruded polymeric layer is laminated to one of the non-coated sides of the fabric polymeric layer and is in contact with that non-coated side of the fabric polymeric layer. In aspects, the fabric polymeric layer is coated on one side, and the extruded polymeric layer is laminated to the non-coated side of the fabric polymeric layer and is in contact with the non-coated side of the fabric polymeric layer. In aspects, the fabric polymeric layer is coated on one side, and the extruded polymeric layer is laminated to the coated side of the fabric polymeric layer and is in contact with the coated side of the fabric polymeric layer. In aspects, the fabric polymeric layer is coated on both sides, and the extruded polymeric layer is laminated to one of the coated sides of the fabric polymeric layer and is in contact with that coated side of the fabric polymeric layer.

Manufacture of a polymeric fabric layer (e.g., of PE, HDPE, PP, etc.) is well-known in the art, including as woven layers/sheets, which can be commercially obtained.

Manufacture of an extruded polymeric layer can be performed using any suitable method known in the art. For example, polymer resin and additive is added to an extruder. The extruder heats the resin and additive to melt them together and uses a screw system to mix them together and push the melted mixture to a forming unit (a die). The mixture is cooled as it moves through the forming unit and pushed up into a bubble using an air system, where the bubble is formed from the resulting film from the forming unit. As is well-known in the art, multiple extruders can be associated with the forming unit such that the bubble film can be generated having multiple layers. At the top of the bubble, the film is cut to form a sheet, which can be wound up into a roll on a winder.

Methods of lamination are also well-known in the art. An exemplary method involves having two separate, rolled films on two separate rolls, unwinding the films such that the films are transversely pressed together at a nip point. Such a method can use a pressure roll, optionally a heated pressure roll, and a another roll, optionally cooled, where the two films are pressed into contact together between the rolls (the nip point).

U.S. Pre-Grant Pub. No. 2008/0233383 describes extrusion and lamination methods in relation to generation of films. US 2008/0233383 is incorporated by reference herein in its entirety.

### Uses of Laminated Films of the Present Disclosure

The laminated films as described herein can be used, for example, as a covering to provide protection of what is underneath the film. The covering can be over, e.g., silage, to provide protection of the silage from water vapor and/or oxygen, which will prolong the useable life of the silage, e.g., by preventing the silage from spoiling.

Other exemplary uses of the laminated films as described herein include, but are not limited to:
lining basements and crawlspaces to prevent radon, methane, and other harmful gases from entering a building;
covering contaminated soil and lining the final filling spaces of the contaminated soil to prevent the harmful organic compounds from leaching into the environment;
laying the film before pouring concrete to prevent radon, methane, and other harmful gases from entering a building;
covering hay to prevent water vapor from penetrating into the hay;
covering grain to prevent transport of oxygen, preventing oxygen from coming into contact with the grain and cause spoilage; and
use as a geomembrane to prevent against odors, methane, radon, and/or volatile organic compounds (e.g., as oil and gas liner containments, storm water runoff containments, pond liners, etc.).

The laminated films as described herein can be used with either the extruded polymeric layer or the fabric polymeric layer (having no coatings, one coating, or two coatings) facing what is underneath the film.

### “Substantially Impermeable”

As used herein, “substantially impermeable” means permitting 20 cc/m²/day or less of gas transfer. For example, the transfer can be 15 cc/m²/day or less, 10 cc/m²/day or less, 5 cc/m²/day or less, 2 cc/m²/day or less, 1 cc/m²/day or less, or 0.5 cc/m²/day or less. For example, the transfer can be 0 cc/m²/day to 20 cc/m²/day, 0 cc/m²/day to 15 cc/m²/day, 0 cc/m²/day to 10 cc/m²/day, 0 cc/m²/day to 5 cc/m²/day, 0 cc/m²/day to 2 cc/m²/day, 0 cc/m²/day to 1 cc/m²/day, 0 cc/m²/day to 0.5 cc/m²/day, 0.5 cc/m²/day to 20 cc/m²/day, 0.5 cc/m²/day to 15 cc/m²/day, 0.5 cc/m²/day to 10 cc/m²/day, 0.5 cc/m²/day to 5 cc/m²/day, 0.5 cc/m²/day to 2 cc/m²/day, 0.5 cc/m²/day to 1 cc/m²/day, 1 cc/m²/day to 20 cc/m²/day, 1 cc/m²/day to 15 cc/m²/day, 1 cc/m²/day to 10 cc/m²/day, 1 cc/m²/day to 5 cc/m²/day, 1 cc/m²/day to 2 cc/m²/day, 2 cc/m²/day to 20 cc/m²/day, 2 cc/m²/day to 15 cc/m²/day, 2 cc/m²/day to 10 cc/m²/day, 2 cc/m²/day to 5 cc/m²/day, 5 cc/m²/day to 20 cc/m²/day, 5 cc/m²/day to 15 cc/m²/day, 5 cc/m²/day to 10 cc/m²/day, 10 cc/m²/day to 20 cc/m²/day, 10 cc/m²/day to 15 cc/m²/day, or 15 cc/m²/day to 20 cc/m²/day.

The permeability of the laminated film can be measured using the method as described in ASTM D3985, entitled, “Standard Test Method for Oxygen Gas Transmission Rate Through Plastic Film and Sheeting Using a Coulometric Sensor.” The ASTM can be ASTM D3985-17.

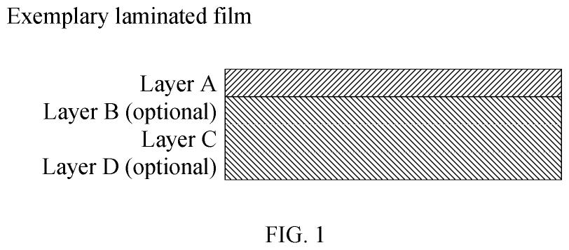

### Exemplary Aspects of the Present Disclosure as Presented in FIG. 1

Layer A can be a blown/extruded layer, which can be, for example, formed from layers fed into an extruder. The resulting layer A can be formed from outside layers that sandwich one or more inside layer(s), the layers together extruded to form layer A. In aspects of the present disclosure, the outside layers fed to the extruder are polyethylene, and the inside layer fed to the extruder is an additive that provides resistance to gas transfer (for example, oxygen and water vapor). Exemplary additives are EVOH and Nylon.

Layers B and D are each optional layers, that when present is/are a coating of layer C. Layer B/D can comprise, consist essentially of, or consist of any suitable low density polymer, for example, LDPE. When present, layer B/D can add strength and/or weight to layer C.

Layer C can be woven, for example a fabric, and can provide high impact strength and/or tensile strength to the laminated film. Layer C can comprise, consist essentially of, or consist of any woven plastic fabric of PE, for example HDPE, or PP.

In an aspect of the present disclosure, layer A, after extrusion, is laminated onto layer C, where layer C is not coated on either side, and layers B and D as shown in FIG. 1 are not present. If layer C is coated on one side, layer A can be laminated onto the coated side or the non-coated side of layer C. For example, layer A can be laminated onto layer B that coats layer C, where layer D as shown in FIG. 1 is not present, and layer A is in contact with layer B. Alternatively, layer A can be laminated onto layer C, where no layer B as shown in FIG. 1 is present, with layer C coated with layer D, which is on the opposite side of layer A and not in contact with layer A. If layer C is coated on both sides, lamination of layer A onto layer C with layers B and D would result in all layers being present as shown in FIG. 1.

### Exemplary Aspects of the Present Disclosure

The following are certain aspects of the present disclosure.

Aspect 1. A laminated film comprising, consisting essentially of, or consisting of:
(a) a fabric polymeric layer,
   wherein the fabric polymeric layer is woven, and
   wherein the fabric polymeric layer comprises, consists essentially of, or consists of polyethylene (PE) or polypropylene (PP); and
(b) an extruded polymeric layer,
wherein the extruded polymeric layer comprises, consists essentially of, or consists of an additive incorporated into the layer that makes the layer substantially impermeable to gases.

Aspect 2. The laminated film of aspect 1, wherein the fabric polymeric layer comprises, consists essentially of, or consists of PE.

Aspect 3. The laminated film of aspect 1, wherein the fabric polymeric layer comprises, consists essentially of, or consists of PP.

Aspect 4. The laminated film of aspect 2, wherein the fabric polymeric layer comprises, consists essentially of, or consists of high density PE (HDPE).

Aspect 5. The laminated film of any one of aspects 1-4, wherein the fabric polymeric layer is not coated on either side.

Aspect 6. The laminated film of any one of aspects 1-4, wherein the fabric polymeric layer is coated on one side.

Aspect 7. The laminated film of aspect 6, wherein the extruded polymeric layer is in contact with the non-coated side of the fabric polymeric layer.

Aspect 8. The laminated film of any one of aspects 1-4, wherein the fabric polymeric layer is coated on both sides.

Aspect 9. The laminated film of any one of aspects 1-8, wherein the additive incorporated into the extruded polymeric layer that makes the layer substantially impermeable to gases is ethylene vinyl alcohol (EVOH) or Nylon.

Aspect 10. The laminated film of aspect 9, wherein the additive is EVOH.

Aspect 11. The laminated film of aspect 9, wherein the additive is Nylon.

Aspect 12. The laminated film of any one of aspects 1-11, wherein the extruded polymeric layer is formed from PE.

Aspect 13. The laminated film of any one of aspects 1-12, wherein the extruded polymeric layer is substantially impermeable to oxygen, water vapor, radon, methane, gaseous odors, or volatile organic compounds.

Aspect 14. The laminated film of aspect 13, wherein the extruded polymeric layer is substantially impermeable to oxygen and water vapor.

Aspect 15. A method of making a laminated film, the method comprising, consisting essentially of, or consisting of:
(1) forming an extruded polymeric layer from a polymer and an additive that makes the extruded polymeric layer substantially impermeable to gases; and
(2) laminating the extruded polymeric layer of (1) onto a fabric polymeric layer, wherein the fabric polymeric layer is woven, and wherein the fabric polymeric layer comprises, consists essentially of, or consists of polyethylene (PE) or polypropylene (PP).

Aspect 16. The method of aspect 15, wherein the fabric polymeric layer comprises, consists essentially of, or consists of PE.

Aspect 17. The method of aspect 15, wherein the fabric polymeric layer comprises, consists essentially of, or consists of PP.

Aspect 18. The method of aspect 16, wherein the fabric polymeric layer comprises, consists essentially of, or consists of high density PE (HDPE).

Aspect 19. The method of any one of aspects 15-18, wherein the fabric polymeric layer is not coated on either side.

Aspect 20. The method of any one of aspects 15-18, wherein the fabric polymeric layer is coated on one side.

Aspect 21. The method of aspect 20, wherein the extruded polymeric layer is laminated to the non-coated side of the fabric polymeric layer.

Aspect 22. The method of any one of aspects 15-18, wherein the fabric polymeric layer is coated on both sides.

Aspect 23. The method of any one of aspects 15-22, wherein the additive that makes the extruded polymeric layer substantially impermeable to gases is ethylene vinyl alcohol (EVOH) or Nylon.

Aspect 24. The method of aspect 23, wherein the additive is EVOH.

Aspect 25. The method of aspect 23, wherein the additive is Nylon.

Aspect 26. The method of any one of aspects 15-25, wherein the polymer of the extruded polymeric layer is PE.

Aspect 27. The method of any one of aspects 15-26, wherein the extruded polymeric layer is substantially impermeable to oxygen, water vapor, radon, methane, gaseous odors, or volatile organic compounds.

Aspect 28. The method of aspect 27, wherein the extruded polymeric layer is substantially impermeable to oxygen and water vapor.

It shall be noted that the Detailed Description merely presents examples of aspects of the present disclosure. Other exemplary aspects are apparent from the entirety of the description herein. It will also be understood by one of ordinary skill in the art that each of these aspects may be used in various combinations with the other aspects provided herein.

The following example further illustrates the present disclosure but, of course, should not be construed as in any way limiting its scope.

### EXAMPLE

This example demonstrates the dry oxygen transmission rate of a laminated film of the present disclosure.

A sample of a laminated film with a white EVOH blown extruded polymeric layer (6% EVOH contained in the layer) and HDPE woven fabric polymeric layer (total of 2 mil thick film) was tested for dry oxygen transmission rate.

The testing was performed with the following test conditions:
Test Gas: Oxygen
Test Gas Concentration: 100% O₂
Test Gas Humidity: 0% RH
Test Gas Pressure: 760 mm Hg
Test Temperature: 23.0 C/73.4 F
Carrier Gas: 98% N,, 2% H,
Carrier Gas Humidity: 0% RH

The sample was analyzed on an Oxtran Oxygen Permeability Instrument, following the testing procedure of ASTM D3985.

The test results are shown in Table 1.

TABLE 1

| | |
|---|---|
| Oxygen Transmission Rate | Steady State or |

| Replicate | cc/(m² · day) | Test Duration |
|---|---|---|
| A | 11.9 | Steady State |
| B | 9.92 | Steady State |

Steady state is defined as a value that changes ≤1% over 24 hrs or ±the low-end specification of the instrument, whichever is greater. If steady state had not been reached, the result at the maximum contracted test duration was reported.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A laminated film comprising:
(a) a fabric polymeric layer,
wherein the fabric polymeric layer is woven, and
wherein the fabric polymeric layer comprises polyethylene (PE) or polypropylene (PP); and
(b) an extruded polymeric layer,
wherein the extruded polymeric layer comprises an additive incorporated into the layer that makes the layer substantially impermeable to gases.

2. The laminated film of claim 1, wherein the fabric polymeric layer comprises PE.

3. The laminated film of claim 1, wherein the fabric polymeric layer comprises PP.

4. The laminated film of claim 2, wherein the fabric polymeric layer comprises high density PE (HDPE).

5. The laminated film of claim 1, wherein the fabric polymeric layer is not coated on either side.

6. The laminated film of claim 1, wherein the fabric polymeric layer is coated on one side.

7. The laminated film of claim 6, wherein the extruded polymeric layer is in contact with the non-coated side of the fabric polymeric layer.

8. The laminated film of claim 1, wherein the fabric polymeric layer is coated on both sides.

9. The laminated film of claim 1, wherein the additive incorporated into the extruded polymeric layer that makes the layer substantially impermeable to gases is ethylene vinyl alcohol (EVOH) or Nylon.

10. The laminated film of claim 9, wherein the additive is EVOH.

11. The laminated film of claim 9, wherein the additive is Nylon.

12. The laminated film of claim 1, wherein the extruded polymeric layer is formed from PE.

13. The laminated film of claim 1, wherein the extruded polymeric layer is substantially impermeable to oxygen, water vapor, radon, methane, gaseous odors, or volatile organic compounds.

14. The laminated film of claim 13, wherein the extruded polymeric layer is substantially impermeable to oxygen and water vapor.

15. The laminated film of claim 4, wherein the additive incorporated into the extruded polymeric layer that makes the layer substantially impermeable to gases is EVOH.

16. The laminated film of claim 4, wherein the extruded polymeric layer is formed from PE.

17. The laminated film of claim 15, wherein the extruded polymeric layer is formed from PE.

18. The laminated film of claim 17, wherein the extruded polymeric layer is substantially impermeable to oxygen, water vapor, radon, methane, gaseous odors, or volatile organic compounds.

19. The laminated film of claim 18, wherein the extruded polymeric layer is substantially impermeable to oxygen and water vapor.

20. A method of making a laminated film, the method comprising:
(1) forming an extruded polymeric layer from a polymer and an additive that makes the extruded polymeric layer substantially impermeable to gases; and
(2) laminating the extruded polymeric layer of (1) onto a fabric polymeric layer, wherein the fabric polymeric layer is woven, and wherein the fabric polymeric layer comprises polyethylene (PE) or polypropylene (PP).

21. The method of claim 20, wherein the fabric polymeric layer comprises PE.

22. The method of claim 20, wherein the fabric polymeric layer comprises PP.

23. The method of claim 21, wherein the fabric polymeric layer comprises high density PE (HDPE).

24. The method of claim 20, wherein the fabric polymeric layer is not coated on either side.

25. The method of claim 20, wherein the fabric polymeric layer is coated on one side.

26. The method of claim 25, wherein the extruded polymeric layer is laminated to the non-coated side of the fabric polymeric layer.

27. The method of claim 20, wherein the fabric polymeric layer is coated on both sides.

28. The method of claim 20, wherein the additive that makes the extruded polymeric layer substantially impermeable to gases is ethylene vinyl alcohol (EVOH) or Nylon.

29. The method of claim 28, wherein the additive is EVOH.

30. The method of claim 28, wherein the additive is Nylon.

31. The method of claim 20, wherein the polymer of the extruded polymeric layer is PE.

32. The method of claim 20, wherein the extruded polymeric layer is substantially impermeable to oxygen, water vapor, radon, methane, gaseous odors, or volatile organic compounds.

33. The method of claim 32, wherein the extruded polymeric layer is substantially impermeable to oxygen and water vapor.

34. The method of claim 23, wherein the additive that makes the extruded polymeric layer substantially impermeable to gases is EVOH.

35. The method of claim 23, wherein the extruded polymeric layer is formed from PE.

36. The method of claim 34, wherein the extruded polymeric layer is formed from PE.

37. The method of claim 36, wherein the extruded polymeric layer is substantially impermeable to oxygen, water vapor, radon, methane, gaseous odors, or volatile organic compounds.

38. The method of claim 37, wherein the extruded polymeric layer is substantially impermeable to oxygen and water vapor.
